(19) United States
(12) Patent Application Publication
(10) Pub. No.: US 2007/0250707 A1
(43) Pub. Date: Oct. 25, 2007

(54) METHOD AND DEVICE FOR ACCESSING DATA USING NEAR FIELD COMMUNICATIONS

(75) Inventor: Hiroyasu NOGUCHI, MALMO (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: Sony Ericsson Mobile Communications AB, LUND (SE)

(21) Appl. No.: 11/379,585

(22) Filed: Apr. 21, 2006

(51) Int. Cl. H04L 9/00

(52) U.S. Cl. 713/164

(57) ABSTRACT

The invention relates to an electronic device (10) with a Near Field Communication (NFC) interface, and a method for accessing data using NFC. The NFC interface of the electronic device is positioned within communication range of a second NFC interface of a second device, whereby data is transferred to the first electronic device from the second electronic device. The data is sorted into a layered data structure including at least two layers, wherein a first layer includes directly presentable first information, such as brief content description, and a second layer includes a communication address to an information source accessible by means of a network connection to download further information.

### FIELD OF THE INVENTION

The present invention relates to electronic devices, and means for data communication using electronic devices. More particularly, the invention relates to a solution for receiving data in an electronic device using a Near Field Communication reader to obtain information related to the data.

### BACKGROUND

Digital mobile telephony has become one of the most important ways of communicating, both for making voice calls and exchanging data. For the mere purpose of exchanging data, network protocols have also evolved for use by means of computers, e.g. in Wireless Local Area Networks (WLAN).

A system for short range radio communication between electronic devices has also been provided under the name Bluetooth™. Bluetooth is basically a wireless personal area network technology, which is an open standard for short-range transmission of digital voice and data between predominantly mobile devices, and supports point-to-point and multipoint applications. Bluetooth typically provides up to 720 Kbps data transfer within a range of 10 meters and up to 100 meters with a power boost. Bluetooth uses omni-directional radio waves that can transmit through walls and other non-metal barriers in the unlicensed 2.4 GHz band.

In recent years, a new technology for even shorter range communication in the mobile telecommunications market has evolved, based on radio frequency identification (RFID) and generally referred to as Near Field Communication (NFC). NFC has been characterized as the intuitive link between consumer devices, and facilitates short-range communication between electronic devices, such as mobile phones, Personal Digital Assistants (PDA), computers and advanced consumer electronics, via a fast and easy wireless connection. The NFC technology has been developed jointly by Royal Philips Electronics and Sony Corporation, and enables consumers to securely exchange and store all kinds of information including ownership rights, credit card numbers, coupons, membership messages, pictures and MP3 files, simply by bringing two devices close together. NFC may act as a secure smart key for access to content and services such as cashless payment, ticketing, online entertainment and access control, and can also be used to automatically configure and initiate wireless connections under other protocols, such as Bluetooth or Wi-Fi, enabling devices to communicate at longer ranges or transfer data at higher rates.

Typically, NFC provides a contactless proximity interaction over a few centimeters which simplifies the issue of identification, as there is less confusion when devices can only connect with their immediate neighbors. A number of NFC trials are currently taking place around the globe. Since December 2005, a major NFC trial has been underway at the Philips Arena stadium in Atlanta, Ga., allowing sports fans to easily buy goods at concession stands and apparel stores. Additionally they are able to access and download mobile content such as ring tones, wallpapers, screensavers and clips from favorite players and artists by holding their NFC-enabled phone in front of a poster embedded with an NFC tag.

NFC runs on the 13.56 MHz frequency band with a read and write range of up to 10 centimeters. It operates at data rates of 106 kbits/s and 212 kbits/s, although higher transmission speeds can be achieved between dedicated NFC devices, initially up to 424 kbits/s with potential for higher bit rates. As NFC devices can operate in an active or passive mode, the technology also offers a unique link to the contactless smart card world as it is compatible with the broadly established contactless smart card infrastructure based on ISO 14443 A (i.e. Philips MIFARE® technology), as well as Sony's FeliCa™ card used for electronic ticketing in public transport and for payment applications. It also allows mobile devices to communicate in passive mode, saving power and extending battery life. Targeted to become a widely adapted contactless infrastructure, NFC is already standardized according to globally accepted standardization bodies, such as ISO (18092), ECMA (340) and ETSI. As is often the case with the devices sharing a single RF band, the communication is half-duplex. The devices implement the “listen before talk” policy—any device must first listen on the carrier and start transmitting a signal only if no other device can be detected transmitting. Furthermore, the NFC protocol distinguishes between the Initiator and the Target of the communication. Any device may be either an Initiator or a Target. The Initiator, as follows from the name, is the device that initiates and controls the exchange of data. The Target is the device that answers the request from the Initiator. The NFC protocol also distinguishes between two modes of operation: Active mode and Passive mode. All devices support both communication modes. The distinction is as follows:

In the Active mode of communication both devices generate their own RF field to carry the data.

In the Passive mode of communication only one device generates the RF field while the other device uses load modulation to transfer the data. The protocol specifies that the Initiator is the device responsible to generate the RF field.

### SUMMARY OF THE INVENTION

Many electronic devices of today are capable of exchanging data with other devices in several different ways. A mobile phone, for instance, is typically configured to communicates with a radio communications network such as a WCDMA network, for voice calls and for downloading or streaming data from content servers. A Bluetooth chip is often also included, enabling short range communication. By using a cord or docking station, it is also possible to connect to the Internet. NFC technology provides yet another means for communication using the same electronic device. However, among the mentioned means for retrieving data using a electronic device, NFC is typically at the lower end in terms of bandwidth and memory space. One of fields of application most commonly referred to in the context of NFC, is to employ RFID-like NFC tags attached to different types of carriers, such as books, DVDs, posters, and so on. When approaching or touching the NFC tag with an electronic device carrying an NFC reader, data stored on a memory chip of the NFC tag is retrieved by the reader to the electronic device. Typically, the memory space on the NFC tag is limited, and besides some direct information the memory preferably includes address information to websites or the like, where more information may be retrieved.

An NFC reader, i.e. an electronic device including an NFC interface configured to acquire data modulated in a radio frequency electromagnetic wave, can read information buried in e.g. an NFC tag placed on a DVD, a book or even from another electronic device. Since the memory size in an NFC tag is limited, the NFC reader is usually connected to another information source, such as a database, either internally in the electronic device or through another communication interface such as the Internet, where more extensive and detailed information is stored. However, the electronic device carrying the NFC reader cannot always be expected to be able to access the information source. When using an electronic device such as a mobile phone, a PDA or laptop to communicatively connect to an NFC tag, download of information is initiated. However, if the read data includes address information to the information source and the electronic device is currently not connected to a communications network to access the address in question, the downloaded information may be incomplete, possibly incoherent, or even unreadable. This dependence on the electronic device being connected to other communication networks when using NFC therefore tends to limit the general desire of NFC being a simple and intuitive solution for communicating data to or from an electronic devices. It is therefore an object of the invention to provide a solution for near field communications which compensates for the discontinuous connectivity of electronic devices to other sources of information.

According to a first aspect of the invention, the stated object is fulfilled by means of a method for accessing data, comprising the steps of:
providing an electronic device having a Near Field Communication (NFC) interface with an antenna connected to a demodulator for acquiring data modulated in an electromagnetic wave, and a second communication interface connectable to a network;
positioning the NFC interface within communication range of a second NFC interface of a second device;
receiving data in the first electronic device from the second electronic device, which data is sorted in at least two layers, wherein a first layer includes directly presentable first information, and a second layer includes a communication address to an information source.

In one embodiment, the data is sorted in at least three layers, where the second layer comprises a communication address to a public information source, and a third layer comprises a communication address to a personal network information source.

In one embodiment, the method comprises the steps of:
detecting if the electronic device is connected to a network;
presenting only the first information if the electronic device is not connected to a network.

In one embodiment, the method comprises the steps of:
detecting if the electronic device is connected to a network;
storing the communication address in a memory of the electronic device if the electronic device is not connected to a network.

In one embodiment, the method comprises the steps of:
detecting if the electronic device is connected to a network;
accessing the information source to retrieve information if the electronic device is connected to a network.

In one embodiment, the second layer comprises URL information.

In one embodiment, the third layer comprises file name information.

In one embodiment, the first information of the first layer includes an identification of content accessible using the communication address of the second layer.

In one embodiment, the NFC interface operates in the 13.56 MHz frequency band.

According to a second aspect, the stated object is fulfilled by a method for providing data using a Near Field Communication (NFC) tag, comprising the steps of:
storing directly presentable first information in a first layer in a memory of the NFC tag;
storing a communication address to an information source in a second layer in the memory;
modulating an electromagnetic wave to include the data of both layers as a layered data structure;
transmitting the modulated electromagnetic wave using an antenna of the NFC tag.

In one embodiment, the method comprises the steps of:
receiving an electromagnetic wave in the antenna, wherein the step of modulating includes
performing load modulation to include the data of both layers as a layered data structure.

In one embodiment, the NFC tag operates in the 13.56 MHz frequency band.

In one embodiment, the data is sorted in at least three layers, where the second layer comprises a communication address to a public information source, comprising the steps of:
storing a communication address to a personal network information source in a third layer in the memory;
modulating the electromagnetic wave to include the data of all layers as a layered data structure.

In one embodiment, the second layer comprises URL information.

In one embodiment, the third layer comprises file name information.

In one embodiment, the information of the first layer includes an identification of content accessible using the communication address of the second layer.

According to a third aspect, the stated object is fulfilled by a Near Field Communication (NFC) device, comprising:
an antenna for sensing an electromagnetic wave,
a circuit including a modulator connected to the antenna for incorporating data in an electromagnetic wave;
a memory connected to the circuit, said memory including a layered data structure including
   directly presentable first information in a first layer, and
   a communication address to an information source in a second layer.

In one embodiment, the layered data structure includes
a communication address to a public information source in the second layer, and
a communication address to a personal network information source in a third layer.

In one embodiment, the circuit comprises:
an electromagnetic wave generator for forming a radio frequency field, connected to the antenna.

In one embodiment, the circuit comprises:
a demodulator connected to the antenna for acquiring data modulated in an electromagnetic wave.

In one embodiment, the circuit comprises:
a load modulator configured to modulate an electromagnetic wave received by the antenna to incorporate data in the electromagnetic wave.

In one embodiment, the second layer comprises URL information.

In one embodiment, the third layer comprises file name information.

In one embodiment, the first information of the first layer includes an identification of content accessible using the communication address of the second layer.

In one embodiment, the NFC tag operates in the 13.56 MHz frequency band.

The subject matter of the aforementioned embodiments may also be combined.

### BRIEF DESCRIPTION OF THE DRAWINGS

The features and advantages of the present invention will be more apparent from the following description of preferred embodiments with reference to the accompanying drawings, on which

FIG. 1 schematically illustrates two electronic devices with NFC capabilities positioned within communicative range of each other;

FIG. 2 schematically illustrates a layered data structure for sorting information in directly presentable information and downloadable information, in a memory of an NFC device.

### DETAILED DESCRIPTION OF PREFERRED EMBODIMENTS

The present invention relates to near field communication of data to and from electronic devices. The electronic device as such may take the shape of e.g. a personal computer, a digital camera, a media player, or a PDA. However, as a best mode of the invention presently known, the invention will mainly be described herein as incorporated in the field of telecommunications, and the electronic device used for acquiring data will therefore occasionally be referred to as a mobile phone. It should be noted, though, that the borders between what can be considered a mobile phone, a portable laptop computer, a PDA, becomes less and less clear since many electronic devices include corresponding functions, even though focus is on different functionalities in the different categories of electronic devices. Furthermore, it should be emphasized that the term comprising or comprises, when used in this description and in the appended claims to indicate included features, elements or steps, is in no way to be interpreted as excluding the presence of other features elements or steps than those expressly stated.

Exemplary embodiments will now be described with references made to the accompanying drawings.

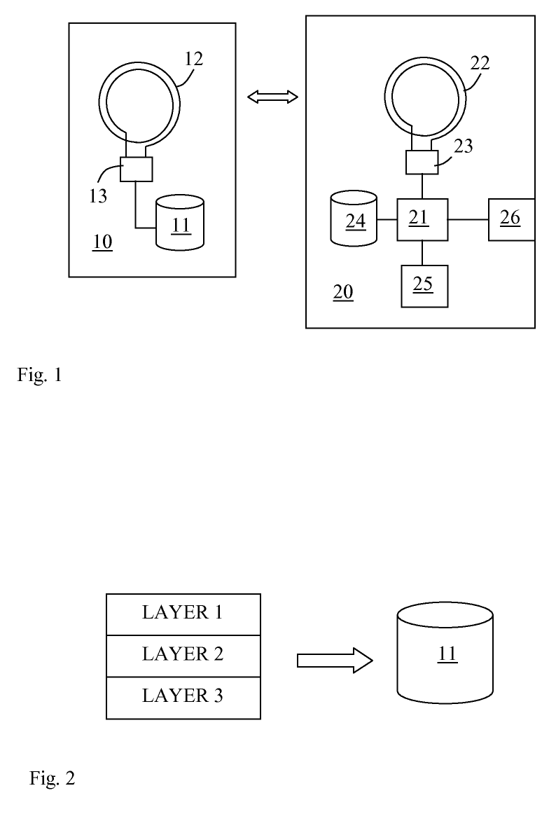

FIG. 1 schematically illustrates a pair of electronic devices 10, 20 including NFC interfaces. In the illustrated embodiment device 10 is a simple NFC tag, whereas device 20 is a mobile phone. However, it should be noted that also device 10 may be an NFC device capable of both active and passive mode communication. Details of the mobile phone 20 as such are of little importance to the invention, but for the sake of clarity it should be mentioned that phone 20 comprises a support structure including a chassis and a cover, directly or indirectly supporting the other components of the terminal. Phone 20 is further devised with a user interface 25 comprising a keypad and a display, and preferably also microphone and a speaker. Phone 20 further comprises a signal transceiver 26, including an antenna and radio transmission and reception electronics, for communicative connection to a base station of a communications network, such as a WCDMA network, a WLAN or a Bluetooth counterpart. A power supply is preferably included in phone 20 in the form of a battery (not shown). Phone 20 is also devised with a control unit 21 comprising a computer system, including a microprocessor with associated memory and software, configured to carry out the tasks of signal processing and data handling in the phone. A data memory 24 is connected to control unit 21. All of these features are, as such, well known in the field of telecommunication devices.

In accordance with the invention, the electronic device here provided in the shape of mobile phone 20 further comprises a contact-free near field communication interface, using radio frequency electromagnetic waves. The embodiments described herein make use of the Near Field Communication (NFC) technology referred to above. The NFC technology is as such standardized and described in the related literature, and will therefore not be described in detail herein, as it lies within the field of knowledge of the skilled person. However, it may be mentioned that the published European patent application EP 1 431 904 A2 describes both the function and structure of an NFC apparatus, including how an NFC apparatus is configured to communicate data with another NFC apparatus, which may be an NFC tag, by transmitting an electromagnetic wave signal using an antenna, and by detecting a modulated electromagnetic wave signal received in response from the NFC tag. For this reason, EP 1 431 904 A2 is incorporated herein by reference.

In order to carry out near field communication, the NFC interface of phone 20 therefore comprises an antenna 22 devised for transmission and reception of electromagnetic waves, connected to a circuit 23. Circuit 23 comprises an electromagnetic wave generator for forming a radio frequency field, connected to the antenna, and a modulator connected to the antenna 22, for sending data by modulating electromagnetic waves. The circuit 23 may also comprise a demodulator connected to the antenna for acquiring data modulated in an electromagnetic wave. The specific structure and function of the NFC interface circuitry is not crucial to the present invention, but the NFC interface may e.g. be configured in accordance with the previously mentioned RFID, MIFARE or FeliCa technologies. Antenna 22 is preferably a closed loop coil, as illustrated. The NFC interface is usable for interacting with external NFC devices placed in proximity to antenna 22, such as beside phone 20 as shown in FIG. 1.

Also NFC tag 10 includes an NFC interface, comprising an antenna 12 devised for transmission and reception of electromagnetic waves, connected to a circuit 13. In the simple embodiment of an NFC tag, circuit 13 need not comprise an electromagnetic wave generator for forming a radio frequency field, but may do so. Circuit 13 preferably includes a modulator in the form of a load modulator, connected to antenna 12, for sending data by load modulating electromagnetic waves received by means of antenna 12. The circuit 13 may also comprise a demodulator connected to the antenna for acquiring data modulated in an electromagnetic wave. A memory 11 is connected to circuit 13, and NFC tag 10 is configured to modulate, e.g. by load modulation, an electromagnetic wave to incorporate data stored in memory 11 in the electromagnetic wave.

The invention involves a method of providing data sorted in layers in a memory 11 of an NFC device 10. More specifically, a layered data structure is proposed for data storage in memory 11 and during transmission of data, where information is sorted in different layers dependent on connection status of a recipient, i.e. the NFC reader communicatively connected to NFC device 10.

FIG. 2 schematically illustrates storing of data in a memory 11 of an NFC interface. In this embodiment, the stored data is sorted into three different layers, each being associated with a certain connection status.

Layer 1 represents a first connection status which is no connection, and includes first information which does not require any further connection for complete access. As such, the first information includes more or less essential information needed to identify the items within the tag memory 11. Examples of such first information include title, author, and brief description of content accessible from other information sources. As such, the information of Layer 1 is directly presentable to a user, e.g. by means of a display included in a user interface 25 of an electronic device 20 comprising NFC reading capabilities.

Layer 2 represents a second connection status, in which public content may be accessed from an information source, such as a server connected to the Internet or a mobile phone network. This layer preferably includes information in the form of one or more communication addresses, such as URL information (Uniform Resource Locator).

Layer 3 represents a third connection status, in which personal, private or classified content public content may be accessed from an information source, such as a PC or a home server. This information may e.g. be accessed over a personal network, possible via the Internet. This layer preferably includes information in the form of file names and device information necessary to find information in a memory or database of the personal network.

The information in the layers is preferably scripted by means of a standard markup language, such as HTML or XML. The information retrievable from a network using the communication addresses of layers 2 and 3 is only accessible when the reading electronic device 20 is connected to the related network, in order to avoid confusion by users. In other words, the layer 2 and 3 information should be accessible according to the request of application in the reading electronic device 20. The device 20 may be temporarily disconnected at the place where the tag information is accessed, and may be reconnected at a WLAN hot spot at which Web information from the URL in the layer 2 or 3 may be accessed. In this case, the application receives layer 2 or 3 information but does not retrieve information over the network immediately. It depends on connectivity of the device. Once the reading device 20 is connected to a network usable for accessing the information associated with layers 2 or 3, such information may be downloaded e.g. using signal transceiver 26. Information download may be initiated automatically when the electronic device 20 establishes a connection with the necessary network, or only upon action by the user of device 20. In one embodiment, the communication addresses of layers 2 and 3 are automatically stored in a memory 24 upon reading the NFC tag 10. In such a case, automatic access of data using a dedicated network connection may be initiated from device 20 also after the NFC communication connection with tag 10 has terminated. Alternatively, information related to layer 2 or 3 may only be accessed if device 20 is simultaneously connected by means of the NFC interface with tag 10 to receive the communication addresses, and by means of signal transceiver 26 to a communications network to access those addresses.

Preferably, the information on tag 10 is stored in the form of a layered data structure in memory 11 when the tag is created. A PC or home server may be configured to create such layers of information, or even an NFC device such as electronic device 20. Furthermore, layered information may preferably be shared between user devices also by other means than NFC. As an example, webpage information may be sent directly to a mobile phone 20, which is an NFC reader/writer, in which mobile phone the webpage information is sorted into a layered data structure in order to classify and minimize information to be shared to other devices.

As previously indicated, NFC device 10 may be a simple NFC tag, e.g. disposed on a sticker. Alternatively, the NFC device 10 may be an electronic device with both reading and writing capabilities, such as another mobile phone. In such an embodiment, circuit 13 comprises an electromagnetic wave generator for forming a radio frequency field, connected to the antenna 12, and preferably also a demodulator connected to antenna 12 for acquiring data modulated in an electromagnetic wave. Where NFC device 10 is a mere NFC tag, configured to operate in passive mode only, circuit 13 preferably comprises a load modulator configured to modulate an electromagnetic wave received by antenna 12, to incorporate data from memory 11 in the electromagnetic wave. As a mere example, the circuits 13 and 23 may e.g. include a Philips PN511 NFC transmission module.

The principles of the present invention have been described in the foregoing by examples of embodiments or modes of operations. However, the invention is not limited to the particular embodiments discussed above, which should be regarded as illustrative rather than restrictive, and it should be appreciated that variations may be made in those embodiments by persons skilled in the art, without departing from the scope of the present invention as defined by the appended claims.

I claim:

1. Method for accessing data, comprising the steps of:
providing an electronic device having a Near Field Communication (NFC) interface with an antenna connected to a demodulator for acquiring data modulated in an electromagnetic wave, and a second communication interface connectable to a network;
positioning the NFC interface within communication range of a second NFC interface of a second device;
receiving data in the first electronic device from the second electronic device, which data is sorted in at least two layers, wherein a first layer includes directly presentable first information, and a second layer includes a communication address to an information source.

2. The method of claim 1, wherein the data is sorted in at least three layers, where the second layer comprises a communication address to a public information source, and a third layer comprises a communication address to a personal network information source.

3. The method of claim 1, comprising the steps of:
detecting if the electronic device is connected to a network;
presenting only the first information if the electronic device is not connected to a network.

4. The method of claim 1, comprising the steps of:
detecting if the electronic device is connected to a network;
storing the communication address in a memory of the electronic device if the electronic device is not connected to a network.

5. The method of claim 1, comprising the steps of:
detecting if the electronic device is connected to a network;
accessing the information source to retrieve information if the electronic device is connected to a network.

6. The method of claim 1, wherein the second layer comprises URL information.

7. The method of claim 2, wherein the third layer comprises file name information.

8. The method of claim 1, wherein the first information of the first layer includes an identification of content accessible using the communication address of the second layer.

9. The method of claim 1, wherein the NFC interface operates in the 13.56 MHz frequency band.

10. Method for providing data using a Near Field Communication (NFC) tag, comprising the steps of:
storing directly presentable first information in a first layer in a memory of the NFC tag;
storing a communication address to an information source in a second layer in the memory;
modulating an electromagnetic wave to include the data of both layers as a layered data structure;
transmitting the modulated electromagnetic wave using an antenna of the NFC tag.

11. The method of claim 10, comprising the steps of:
receiving an electromagnetic wave in the antenna, wherein the step of modulating includes
performing load modulation to include the data of both layers as a layered data structure.

12. The method of claim 10, wherein the NFC tag operates in the 13.56 MHz frequency band.

13. The method of claim 10, wherein the data is sorted in at least three layers, where the second layer comprises a communication address to a public information source, comprising the steps of:
storing a communication address to a personal network information source in a third layer in the memory;
modulating the electromagnetic wave to include the data of all layers as a layered data structure.

14. The method of claim 10, wherein the second layer comprises URL information.

15. The method of claim 13, wherein the third layer comprises file name information.

16. The method of claim 10, wherein the first information of the first layer includes an identification of content accessible using the communication address of the second layer.

17. A Near Field Communication (NFC) device, comprising:
an antenna for sensing an electromagnetic wave,
a circuit including a modulator connected to the antenna for incorporating data in an electromagnetic wave;
a memory connected to the circuit, said memory including a layered data structure including
directly presentable first information in a first layer, and
a communication address to an information source in a second layer.

18. The NFC device of claim 17, wherein the layered data structure includes
a communication address to a public information source in the second layer, and
a communication address to a personal network information source in a third layer.

19. The NFC device of claim 17, wherein the circuit comprises:
an electromagnetic wave generator for forming a radio frequency field, connected to the antenna.

20. The NFC device of claim 17, wherein the circuit comprises:
a demodulator connected to the antenna for acquiring data modulated in an electromagnetic wave.

21. The NFC device of claim 17, wherein the circuit comprises:
a load modulator configured to modulate an electromagnetic wave received by the antenna to incorporate data in the electromagnetic wave.

22. The NFC device of claim 17, wherein the second layer comprises URL information.

23. The NFC device of claim 18, wherein the third layer comprises file name information.

24. The NFC device of claim 17, wherein the first information of the first layer includes an identification of content accessible using the communication address of the second layer.

25. The NFC device of claim 17, wherein the NFC tag operates in the 13.56 MHz frequency band.
